(19) United States
(12) Patent Application Publication
(10) Pub. No.: US 2022/0193570 A1
(43) Pub. Date: Jun. 23, 2022

(54) ASSEMBLED LUMINOUS TOY BALL

(71) Applicant: FOLUCK INTERNATIONAL CO.,LTD., Taoyuan Hsien (TW)

(72) Inventor: Ming-Tay Hsu, Taoyuan Hsien (TW)

(21) Appl. No.: 17/131,334

(22) Filed: Dec. 22, 2020

(51) Int. Cl. A63H 33/06; A63H 5/00; A63H 33/22

(52) U.S. Cl. CPC A63H 33/06; A63H 33/22; A63H 5/00

(57) ABSTRACT

An assembled luminous toy ball includes a ball body. A light-emitting device and a sounding device are provided in the ball body. An outside of the ball body is provided with a plurality of fixing rods. The fixing rods are hard rods. All or part of the fixing rods is sleeved with a removable assembled member. After adopting the above structure, the DIY luminous toy ball has more comprehensive functions. The user can assemble the luminous toy ball with his/her favorite graphics or letters. The luminous toy ball is more interesting.

### FIELD OF THE INVENTION

The present invention relates to a children's toy, and more particularly to an assembled luminous toy ball.

### BACKGROUND OF THE INVENTION

A luminous toy ball is a common children's toy. It is widely loved by children because the toy ball can emit colorful light and children's songs. However, the conventional luminous toy ball only has the functions of light and sound. The function is relatively single.

### SUMMARY OF THE INVENTION

In view of the defects of the conventional luminous ball, the primary object of the present invention is to provide a luminous toy ball with more diverse functions.

In order to achieve the above object, according to one aspect of the present invention, an assembled luminous toy ball is provided. The assembled luminous toy ball comprises a ball body. A light-emitting device and a sounding device are provided in the ball body. An outside of the ball body is provided with a plurality of fixing rods. The fixing rods are hard rods. All or part of the fixing rods is sleeved with a removable assembled member.

In the assembled luminous toy ball, the plurality of fixing rods formed of hard rods is arranged on the outside of the toy ball, and the assembled member can be sleeved on the fixing rod, so that the luminous toy ball has the function of assembling building blocks.

### BRIEF DESCRIPTION OF THE DRAWINGS

These and/or other aspects will become apparent and more readily appreciated from the following description of the embodiments, taken in conjunction with the accompanying drawings, in which:

FIG. 1 is a schematic view of the assembled luminous toy ball according to the present invention.

### DETAILED DESCRIPTION OF THE PREFERRED EMBODIMENTS

Embodiments of the present invention will now be described, by way of example only, with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art.

Spatially relative terms, such as “center,” “upper,” “lower,” “left,” “right,” “vertical,” “level,” “inner,” “outer,” “bottom,” “top,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures.

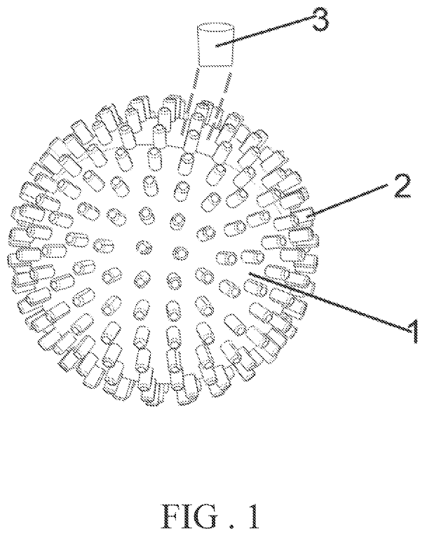

As shown in FIG. 1, an assembled luminous toy ball according to an embodiment of the present invention comprises a conventional ball body 1. A conventional light-emitting device and a conventional sounding device are provided in the ball body 1. The improvement of this embodiment is that a plurality of fixing rods 2 is fixedly connected to the outer wall of the ball body 1. The fixing rods 2 are hard rods. All or part of the fixing rods 2 is sleeved with a removable assembled member 3, so that the luminous toy ball has the function of assembling a toy. This makes the function of the luminous toy ball more comprehensive and more interesting.

It should be understood that the exemplary embodiments described therein should be considered in a descriptive sense only and not for purposes of limitation. Descriptions of features or aspects within each embodiment should typically be considered as available for other similar features or aspects in other embodiments. While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

1. An assembled luminous toy ball, comprising:
a ball body, a light-emitting device and a sounding device being provided in the ball body,
a plurality of hard rods fixed on an outside of the ball body and
a removable member sleeved on one of the plurality of hard rods.
